(19) United States
(12) Patent Application Publication
(10) Pub. No.: US 2026/0136271 A1
(43) Pub. Date: May 14, 2026

(54) ON-DEMAND SYSTEM INFORMATION AND UPDATED SYSTEM INFORMATION ACQUISITION

(71) Applicant: QUALCOMM Incorporated, San Diego, CA (US)

(72) Inventors: Navid ABEDINI, Basking Ridge, NJ (US); Jianghong LUO, Skillman, NJ (US); Hung Dinh LY, San Diego, CA (US)

(21) Appl. No.: 19/368,688

(22) Filed: Oct. 24, 2025

Related U.S. Application Data
(60) Provisional application No. 63/718,432, filed on Nov. 8, 2024.

(51) Int. Cl. H04W 48/16; H04W 52/02

(52) U.S. Cl. CPC H04W 48/16; H04W 52/0203; H04W 52/0235

(57) ABSTRACT

Various aspects of the present disclosure generally relate to wireless communication. In some aspects, a user equipment (UE) may receive, from a network energy savings (NES) cell, an indication to acquire updated system information associated with the NES cell. The UE may obtain a current remaining minimum system information (RMSI) physical downlink control channel (PDCCH) configuration associated with the NES cell. The UE may acquire, from the NES cell, the updated system information in accordance with the current RMSI PDCCH configuration. Numerous other aspects are described.

### CROSS-REFERENCE TO RELATED APPLICATION

This Patent Application claims priority to U.S. Provisional Patent Application No. 63/718,432, filed on November 8, 2024, entitled “ON-DEMAND SYSTEM INFORMATION AND UPDATED SYSTEM INFORMATION ACQUISITION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with on-demand system information and system information change.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to receive, from a network energy savings (NES) cell, an indication to acquire updated system information associated with the NES cell. The one or more processors may be configured to obtain a current remaining minimum system information (RMSI) physical downlink control channel (PDCCH) configuration associated with the NES cell. The one or more processors may be configured to acquire, from the NES cell, the updated system information in accordance with the current RMSI PDCCH configuration.

Some aspects described herein relate to a UE for wireless communication. The UE may include one or more memories and one or more processors coupled to the one or more memories. The one or more processors may be configured to receive, from a neighbor cell, an uplink wakeup signal (UL-WUS) configuration associated with an NES cell. The one or more processors may be configured to identify a current system information block (SIB) transmission mode associated with the NES cell in accordance with the UL-WUS configuration indicating that the NES cell supports at least an on-demand SIB mode and an always-on SIB mode. The one or more processors may be configured to acquire, from the NES cell, system information associated with the NES cell in accordance with the current SIB transmission mode associated with the NES cell.

Some aspects described herein relate to a method of wireless communication performed by a UE. The method may include receiving, from an NES cell, an indication to acquire updated system information associated with the NES cell. The method may include obtaining a current RMSI PDCCH configuration associated with the NES cell. The method may include acquiring, from the NES cell, the updated system information in accordance with the current RMSI PDCCH configuration.

Some aspects described herein relate to a method of wireless communication performed by a UE. The method may include receiving, from a neighbor cell, an UL-WUS configuration associated with an NES cell. The method may include identifying a current SIB transmission mode associated with the NES cell in accordance with the UL-WUS configuration indicating that the NES cell supports at least an on-demand SIB mode and an always-on SIB mode. The method may include acquiring, from the NES cell, system information associated with the NES cell in accordance with the current SIB transmission mode associated with the NES cell.

Some aspects described herein relate to a non-transitory computer-readable medium that stores a set of instructions for wireless communication by a UE. The set of instructions, when executed by one or more processors of the UE, may cause the UE to receive, from an NES cell, an indication to acquire updated system information associated with the NES cell. The set of instructions, when executed by one or more processors of the UE, may cause the UE to obtain a current RMSI PDCCH configuration associated with the NES cell. The set of instructions, when executed by one or more processors of the UE, may cause the UE to acquire, from the NES cell, the updated system information in accordance with the current RMSI PDCCH configuration.

Some aspects described herein relate to a non-transitory computer-readable medium that stores a set of instructions for wireless communication. The set of instructions, when executed by one or more processors of a UE, may cause the UE to receive, from a neighbor cell, an UL-WUS configuration associated with an NES cell. The set of instructions, when executed by one or more processors of the UE, may cause the UE to identify a current SIB transmission mode associated with the NES cell in accordance with the UL-WUS configuration indicating that the NES cell supports at least an on-demand SIB mode and an always-on SIB mode. The set of instructions, when executed by one or more processors of the UE, may cause the UE to acquire, from the NES cell, system information associated with the NES cell in accordance with the current SIB transmission mode associated with the NES cell.

Some aspects described herein relate to an apparatus for wireless communication. The apparatus may include means for receiving, from an NES cell, an indication to acquire updated system information associated with the NES cell. The apparatus may include means for obtaining a current RMSI PDCCH configuration associated with the NES cell. The apparatus may include means for acquiring, from the NES cell, the updated system information in accordance with the current RMSI PDCCH configuration.

Some aspects described herein relate to an apparatus for wireless communication. The apparatus may include means for receiving, from a neighbor cell, an UL-WUS configuration associated with an NES cell. The apparatus may include means for identifying a current SIB transmission mode associated with the NES cell in accordance with the UL-WUS configuration indicating that the NES cell supports at least an on-demand SIB mode and an always-on SIB mode. The apparatus may include means for acquiring, from the NES cell, system information associated with the NES cell in accordance with the current SIB transmission mode associated with the NES cell.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of a synchronization signal hierarchy.

FIG. 4 is a diagram illustrating an example call flow for acquiring minimum system information and other system information.

FIG. 5 is a diagram illustrating example call flows for requesting and acquiring an on-demand system information block carrying remaining minimum system information for a network energy savings cell.

FIG. 6 is a diagram illustrating an example call flow associated with on-demand system information and updated system information acquisition.

FIG. 7 is a diagram illustrating an example process performed, for example, at a user equipment (UE) or an apparatus of a UE.

FIG. 8 is a diagram illustrating an example process performed, for example, at a UE or an apparatus of a UE.

FIG. 9 is a diagram of an example apparatus for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy savings (NES) and/or network energy efficiency measures are expected to have increased importance in wireless network operations for various reasons, such as climate change mitigation, environmental sustainability, and/or network cost reduction, among other examples. For example, although 5G New Radio (NR) generally offers a significant energy efficiency improvement per gigabyte over previous generations (e.g., long term evolution (LTE)), some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs (e.g., fuel and electricity) are about one-fourth of the total cost to operate a wireless network, and about half of the energy consumption is associated with a radio access network (RAN). Accordingly, measures to increase network energy savings and/or improve energy efficiency are factors that may drive adoption and/or expansion of wireless networks.

One technique to increase energy efficiency in a RAN is to enable “on-demand” broadcast transmissions by a network node and/or a cell. For example, to reduce power consumption at a network node, the network node may transmit certain broadcast communications (e.g., system information communications, synchronization signal blocks (SSBs), and/or system information blocks (SIBs)) in an on-demand manner (e.g., upon request, rather than on a periodic basis or following a periodic schedule). In some examples, an on-demand broadcast communication may include one or more communications that carry at least a portion of minimum system information, such as an SSB that carries a master information block (MIB) and/or a SIB type 1 (SIB1) or another SIB (e.g., as defined, or otherwise fixed, by a wireless communication standard, such as the 3GPP). For example, a MIB and SIB1 together carry minimum system information to support initial access, measurement, camping, cell selection or reselection, and/or acquisition of any other system information associated with a cell, such that SIB1 alone is also known as remaining minimum system information (RMSI). In some examples, an SSB and/or SIB1 may be transmitted via a cell to support initial access, measurement, camping, and/or cell selection or reselection by a user equipment (UE). Typically, such communications are periodically broadcasted via the cell (e.g., following a periodic schedule where the communication(s) are transmitted one or more times, and often beamswept in multiple beam directions, in each period) so that idle and/or inactive UEs and/or UEs moving into a geographic region of a cell can receive the communications and establish a connection via the cell.

Accordingly, one way to reduce network power consumption is to reduce transmissions of such communications such that, for example, an SSB and/or SIB1 is transmitted less frequently by a cell operating in an NES mode (or NES state). For example, a cell (or network node associated with a cell) may operate in an NES mode or an NES state associated with an on-demand SIB1, where the SIB1 is transmitted only upon request by a UE, in order to reduce overhead and/or reduce power consumption. For example, a cell may operate in an NES mode or an NES state associated with an on-demand SIB1 during periods with low activity (e.g., there are not many UEs entering and/or exiting the coverage of the cell, or there are not many UEs that are attempting to establish a connection), in which case periodically broadcasting SIB1 (e.g., every 20 or 160 milliseconds), or broadcasting SIB1 in many SSB beam directions, may be wasteful. In such cases, the cell may broadcast SIB1 only on-demand (e.g., only upon request by a UE, where the request may be carried in an uplink wakeup signal (UL-WUS), or in a subset of SSB beam directions). For example, a UE in an idle or inactive mode or a UE that has detected or selected a cell associated with an on-demand SIB1 state may transmit an UL-WUS to request and acquire the on-demand SIB1 (e.g., in order to camp on the cell, connect to the cell, or prepare to connect to the cell).

In some examples, the UL-WUS configuration for requesting the on-demand SIB1 may be provided by a neighboring cell or assisting cell, sometimes referred to as cell A or a cell operating according to a cell A configuration. Additionally, or alternatively, in some examples, the NES cell associated with the on-demand SIB1 may provide the UL-WUS configuration. In either case, after a UE acquires the on-demand SIB1 and starts to camp on the NES cell, the UE may be notified when there is any change to the system information (e.g., via a short message, a paging early indication (PEI), a paging physical downlink shared channel (PDSCH), and/or a low power wakeup signal (LP-WUS), among other examples). In such cases, the NES cell may proactively transmit SIB1 for a few cycles to allow UEs to acquire the updated system information, and the NES cell may provide the UL-WUS configuration associated with the NES cell in one or more SIBs. However, acquiring the updated system information may pose challenges because the UE generally uses an RMSI physical downlink control channel (PDCCH) to monitor for an RMSI PDCCH that schedules an RMSI PDSCH carrying the on-demand SIB1. For example, a MIB typically includes the RMSI PDCCH configuration (e.g., in a PDCCHConfigSIB1 parameter), but the field in the MIB that typically provides the RMSI PDCCH configuration is repurposed for an NES cell to indicate parameters to assist a UE in finding another sync raster with a cell defining SSB (CD-SSB) (e.g., because an SSB associated with an NES cell operating in an on-demand SIB1 transmission state is typically a non-cell-defining SSB (NCD-SSB)).

Accordingly, because the RMSI PDCCH field in a MIB associated with an NES cell is repurposed to provide raster assistance information, the RMSI PDCCH configuration for an NES cell is typically provided in the UL-WUS configuration associated with the NES cell. As a result, when a UE camping on an NES cell receives a system information update indication for the NES cell and attempts to reacquire the MIB and SIB1 for the NES cell, the MIB does not include the RMSI PDCCH configuration that indicates the parameters for receiving an RMSI PDCCH that schedules the on-demand SIB1. Furthermore, the previously acquired RMSI PDCCH configuration may no longer be valid (e.g., the RMSI PDCCH configuration may have changed, and the change to the RMSI PDCCH configuration may be reason for the system information change notification). In such cases, the UE may be unable to receive the RMSI PDCCH that schedules the on-demand SIB1, and therefore may fail to acquire the updated system information. Furthermore, in some cases, the NES cell may support multiple SIB1 transmission states. For example, the NES cell may operate in a first SIB1 transmission state where SIB1 is broadcasted in an always-on manner (e.g., transmitted periodically in a beam-swept manner over all SSB beam directions), or in a second SIB1 transmission state where SIB1 is provided on-demand (e.g., SIB1 is transmitted only in response to an UL-WUS, or only in a subset of SSB beam directions). Furthermore, in some cases, the NES cell may operate in a third SIB1 transmission state, or SIB1-less state, where SIB1 is not transmitted at all. Accordingly, enabling initial acquisition or reacquisition of SIB1 from an NES cell may pose challenges in cases where the UE does not know the current SIB1 transmission state.

Various aspects relate generally to techniques to enable a UE to identify a current SIB1 transmission state associated with a NES cell (e.g., always-on SIB1, on-demand SIB1, or SIB1-less), and to obtain a current RMSI PDCCH configuration to acquire updated system information associated with a NES cell operating in accordance with the on-demand SIB1 transmission state. For example, in some aspects, a UE may identify the current SIB1 transmission state by blindly monitoring for an RMSI PDCCH (e.g., according to an RMSI PDCCH configuration indicated in an UL-WUS configuration for the NES cell), such that the NES cell may be operating in the always-on state in cases where SIB1 is received within a time period or in the on-demand state in cases where SIB1 is not received within the time period. Additionally, or alternatively, the SIB1 transmission state associated with a NES cell may be indicated in the MIB or UL-WUS configuration associated with an NES cell, or in a random access response (RAR) message during a random access procedure. The UE may then monitor for and acquire SIB1 from a NES cell in accordance with the RMSI PDCCH configuration indicated in the UL-WUS configuration and the current SIB1 transmission state. Furthermore, in cases where the NES cell is operating in the on-demand SIB1 transmission state, the UL-WUS configuration and/or RAR may indicate spatial information (e.g., SSB beam directions) for the on-demand SIB1.

Some aspects described herein further relate to techniques for the UE to acquire a current RMSI PDCCH configuration for a NES cell, when the UE receives a system information update notification after SIB1 has been initially acquired. For example, in some aspects, the MIB associated with the NES cell may include a field to indicate a resource element (RE) offset associated with an SSB with respect to a common resource block (RB) in an RB grid, referred to herein as a k_SSB field, which may be set to an invalid value that indicates that the NES cell supports an on-demand SIB1 transmission state. In such cases, the MIB can indicate the RMSI PDCCH configuration in the RMSI PDCCH configuration field, rather than repurposing the RMSI PDCCH configuration field for raster assistance information, and the UE may assume that a valid k_SSB value that was previously indicated for the NES cell remains unchanged. Alternatively, in some aspects, the UE may assume that the RMSI PDCCH configuration in effect prior to the system information update notification remains unchanged, or the UE may blindly monitor for the RMSI PDCCH using the RMSI PDCCH configuration in effect prior to the system information update notification (e.g., such that the UE will either receive the RMSI PDSCH carrying the on-demand SIB1 if the RMSI PDCCH configuration is unchanged, or the UE may obtain an updated UL-WUS configuration that indicates the current RMSI PDCCH configuration from the neighboring or assisting cell if the RMSI PDCCH is not received). Additionally, or alternatively, the NES cell or the neighboring or assisting cell may transmit a message to the UE to indicate whether the RMSI PDCCH configuration has changed, such that the UE may either reacquire SIB1 in cases where the RMSI PDCCH configuration is unchanged or obtain an updated UL-WUS configuration that indicates the current RMSI PDCCH configuration in cases where the RMSI PDCCH configuration has changed.

Particular aspects of the subject matter described in this disclosure can be implemented to realize one or more of the following potential technical advantages. In some examples, by obtaining the current RMSI PDCCH configuration when a system information update indication is received, the UE can use the current RMSI PDCCH configuration to receive the RMSI PDCCH that schedules the RMSI PDSCH carrying the SIB1, and thereby acquire the updated system information associated with the NES cell. Furthermore, by providing techniques to allow the UE to obtain the current RMSI PDCCH configuration when the NES cell is operating in the on-demand SIB1 transmission state, the NES cell can remain in the on-demand SIB1 transmission state (e.g., transmitting SIB1 only in response to an UL-WUS, or only in a limited number of SSB beam directions) to save energy. Furthermore, by identifying the current SIB1 transmission state, the UE may adjust SIB1 acquisition behavior accordingly. For example, in the always-on SIB1 transmission state, the UE may avoid transmitting an UL-WUS to request SIB1, which may conserve power at the UE and reduce signaling overhead because the NES cell is broadcasting SIB1 regardless of any UL-WUS. Alternatively, in the on-demand SIB1 transmission state, the UE may avoid monitoring for an always-on SIB1 that will not be transmitted, which may reduce SIB1 acquisition latency and conserve UE power. Alternatively, in the SIB1-less transmission state, the UE may avoid attempting to acquire SIB1 altogether. In this way, some aspects described herein may reduce uplink and/or downlink signaling, conserve energy and radio resources at the UE and the NES cell, and optimize RAN load management by reducing the number of SIB broadcasts or SIB transmissions.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

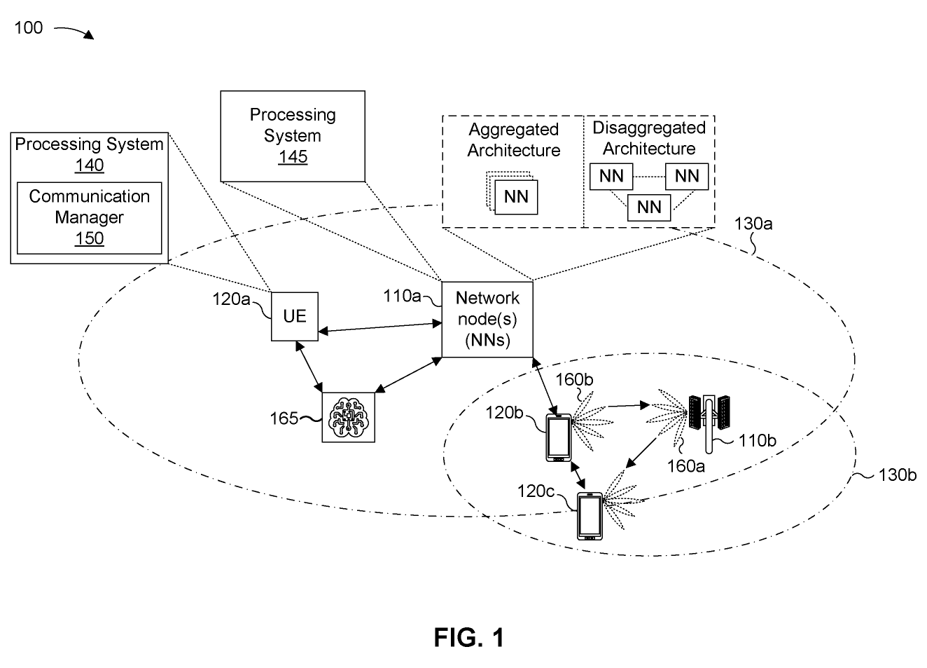

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

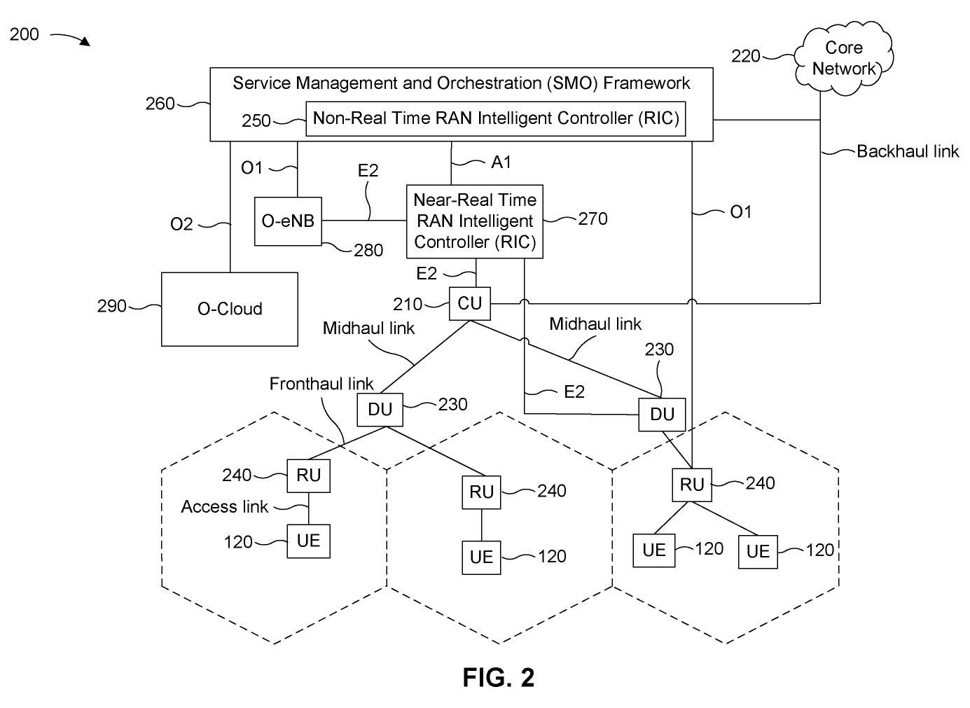

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, from an NES cell, an indication to acquire updated system information associated with the NES cell; obtain a current RMSI PDCCH configuration associated with the NES cell; and acquire, from the NES cell, the updated system information in accordance with the current RMSI PDCCH configuration. Additionally, or alternatively, the communication manager 150 may receive, from a neighbor cell, an UL-WUS configuration associated with an NES cell; identify a current SIB transmission mode associated with the NES cell in accordance with the UL-WUS configuration indicating that the NES cell supports at least an on-demand SIB mode and an always-on SIB mode; and acquire, from the NES cell, system information associated with the NES cell in accordance with the current SIB transmission mode associated with the NES cell. Additionally, or alternatively, the communication manager 150 may perform one or more other operations described herein.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

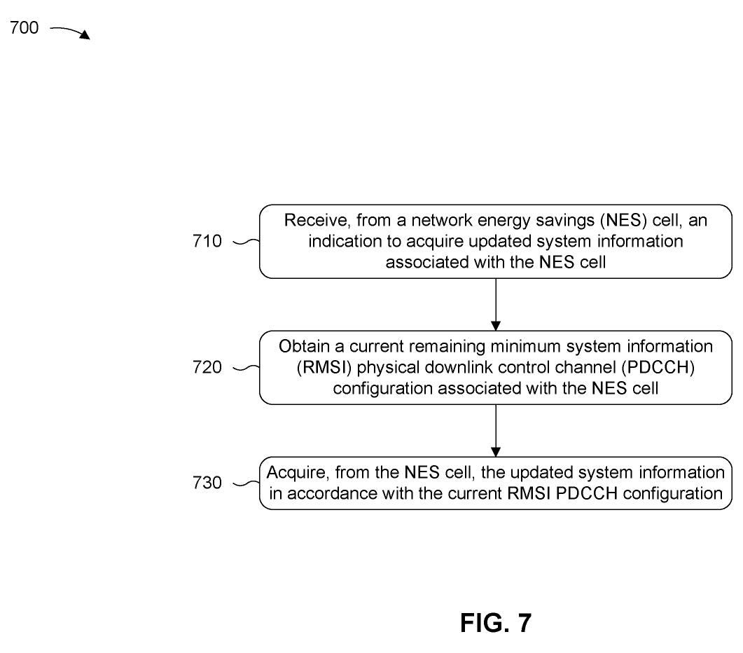

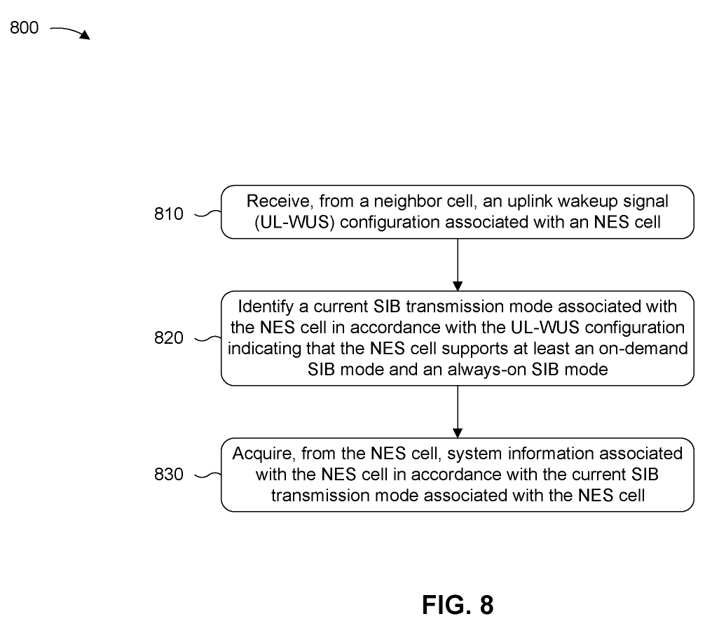

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with on-demand system information and updated system information acquisition, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

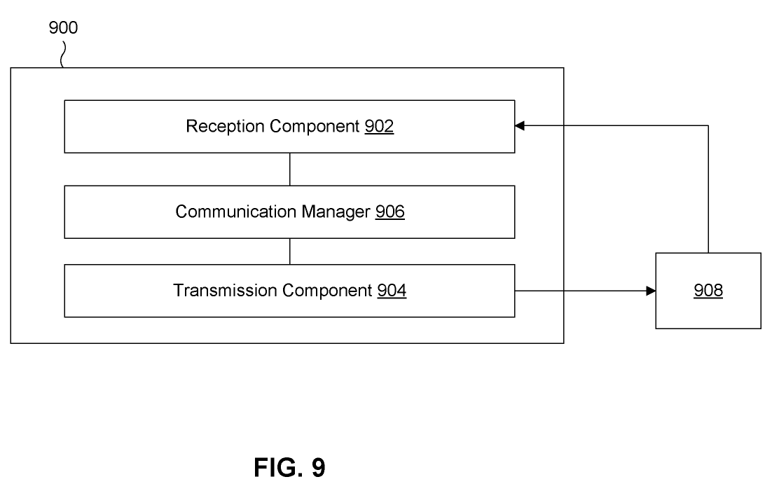

In some aspects, the UE 120 includes means for receiving, from an NES cell, an indication to acquire updated system information associated with the NES cell; means for obtaining a current RMSI PDCCH configuration associated with the NES cell; and/or means for acquiring, from the NES cell, the updated system information in accordance with the current RMSI PDCCH configuration. Additionally, or alternatively, the UE 120 includes means for receiving, from a neighbor cell, an UL-WUS configuration associated with an NES cell; means for identifying a current SIB transmission mode associated with the NES cell in accordance with the UL-WUS configuration indicating that the NES cell supports at least an on-demand SIB mode and an always-on SIB mode; and/or means for acquiring, from the NES cell, system information associated with the NES cell in accordance with the current SIB transmission mode associated with the NES cell. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

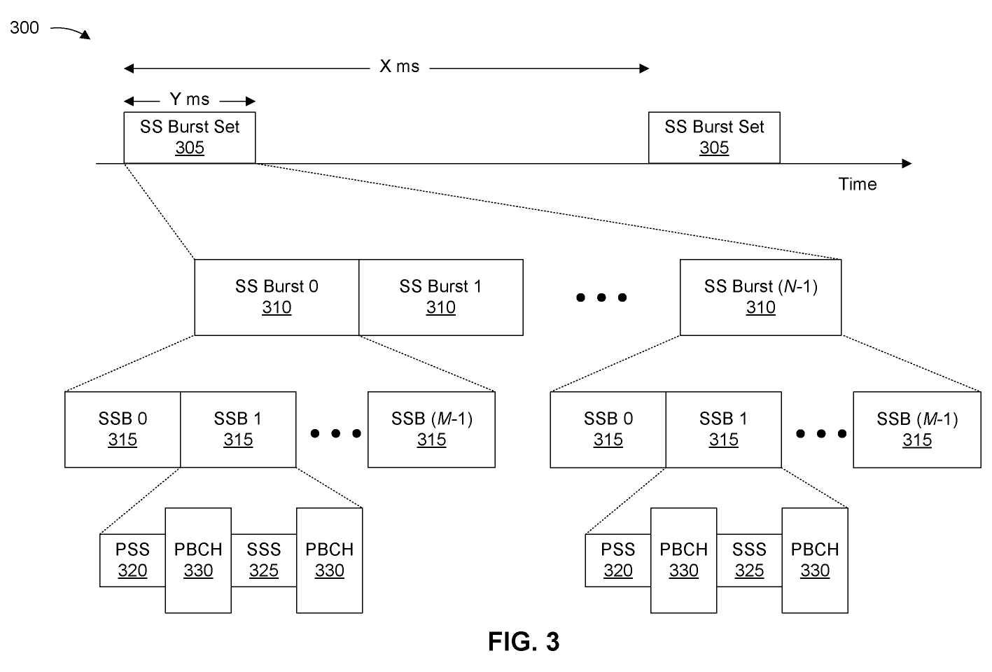

FIG. 3 is a diagram illustrating an example 300 of a synchronization signal (SS) hierarchy. As shown in FIG. 3, the SS hierarchy may include an SS burst set 305, which may include multiple SS bursts 310, shown as SS burst 0 through SS burst N – 1, where N is a maximum number of repetitions of the SS burst 310 that may be transmitted by one or more network nodes. As further shown, each SS burst 310 may include one or more SSBs 315, shown as SSB 0 through SSB M – 1, where M is a maximum number of SSBs 315 that can be carried by an SS burst 310. In some aspects, different SSBs 315 may be beam-formed differently (e.g., transmitted using different beams), and may be used for cell search, cell acquisition, beam management, and/or beam selection (e.g., as part of an initial network access procedure). An SS burst set 305 may be periodically transmitted by a wireless node (e.g., a network node 110), such as every X milliseconds, as shown in FIG. 3. In some aspects, an SS burst set 305 may have a fixed or dynamic length, shown as Y milliseconds in FIG. 3. In some cases, an SS burst set 305 or an SS burst 310 may be referred to as a discovery reference signal (DRS) transmission window or an SSB measurement time configuration (SMTC) window.

In some aspects, an SSB 315 may include resources that carry a PSS 320, an SSS 325, and/or a PBCH 330. In some aspects, the PSS 320 may indicate a physical layer identity associated with a cell and may enable synchronization up to a periodicity of the PSS 320, the SSS 325 may indicate a physical layer cell identity (PCI) group number associated with the cell (e.g., where the physical layer identity indicated in the PSS 320 and the PCI group number indicated in the SSS 325 enable the PCI associated with the cell to be calculated), and the PBCH 330 may carry a MIB that includes parameters to acquire one or more SIBs. In some aspects, multiple SSBs 315 are included in an SS burst 310 (e.g., with transmission on different beams), and the PSS 320, the SSS 325, and/or the PBCH 330 may be the same across each SSB 315 of the SS burst 310. In some aspects, a single SSB 315 may be included in an SS burst 310. In some aspects, the SSB 315 may be at least four symbols (e.g., OFDM symbols) in length, where each symbol carries one or more of the PSS 320 (e.g., occupying one symbol), the SSS 325 (e.g., occupying one symbol), and/or the PBCH 330 (e.g., occupying two symbols). In some aspects, an SSB 315 may be referred to as an SS/PBCH block.

In some aspects, the symbols of an SSB 315 are consecutive, as shown in FIG. 3. In some aspects, the symbols of an SSB 315 are non-consecutive. Similarly, in some aspects, one or more SSBs 315 of the SS burst 310 may be transmitted in consecutive radio resources (e.g., consecutive symbols) during one or more slots. Additionally, or alternatively, one or more SSBs 315 of the SS burst 310 may be transmitted in non-consecutive radio resources.

In some aspects, the SS bursts 310 may have a burst period, and the SSBs 315 of the SS burst 310 may be transmitted by a wireless node (e.g., a network node 110) according to the burst period. In this case, the SSBs 315 may be repeated during each SS burst 310. In some aspects, the SS burst set 305 may have a burst set periodicity, whereby the SS bursts 310 of the SS burst set 305 are transmitted by the wireless node according to the fixed burst set periodicity. In other words, the SS bursts 310 may be repeated during each SS burst set 305.

In some aspects, an SSB 315 may include an SSB index, which may correspond to a beam used to carry the SSB 315. A UE 120 may monitor for and/or measure SSBs 315 using different Rx beams during an initial network access procedure and/or a cell search procedure, among other examples. Based at least in part on the monitoring and/or measuring, the UE 120 may indicate one or more SSBs 315 with a best signal parameter (e.g., an RSRP parameter) to a network node 110 (e.g., directly or via one or more other network nodes). The network node 110 and the UE 120 may use the one or more indicated SSBs 315 to select one or more beams to be used for communication between the network node 110 and the UE 120 (e.g., for a RACH procedure). Additionally, or alternatively, the UE 120 may use the SSB 315 and/or the SSB index to determine a cell timing for a cell via which the SSB 315 is received (e.g., a serving cell).

As indicated above, FIG. 3 is provided as an example. Other examples may differ from what is described with regard to FIG. 3.

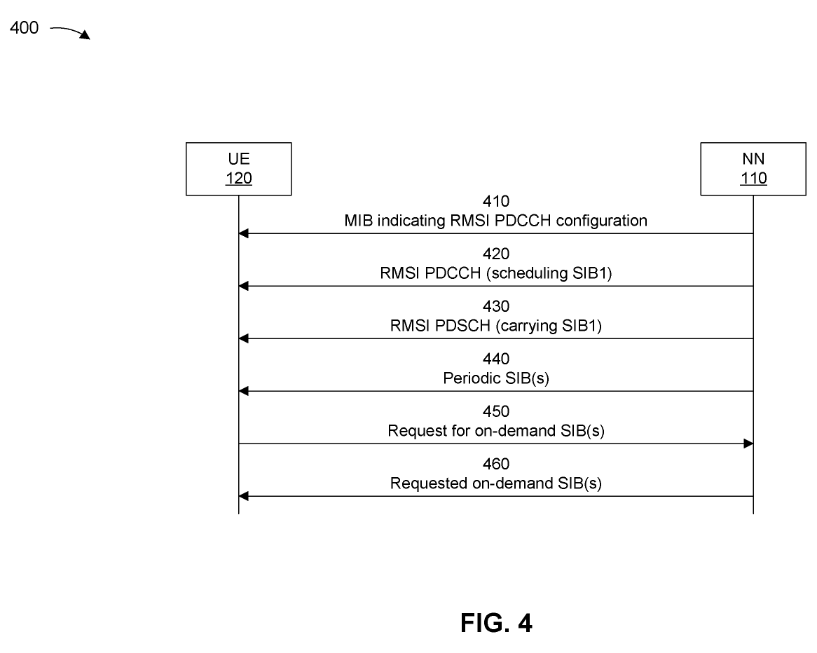

FIG. 4 is a diagram illustrating an example call flow 400 for acquiring minimum system information and other system information. As shown in FIG. 4, example call flow 400 includes communication between a UE 120 and a network node 110. In some aspects, the UE 120 and the network node 110 may communicate in a wireless network, such as wireless communication network 100, via a wireless access link. As described herein, minimum system information associated with the network node 110 may be indicated in a MIB and SIB1, such that SIB1 alone is also known as RMSI. Accordingly, the UE 120 may acquire minimum system information to acquire time and frequency synchronization with the network node 110 and derive sufficient information to obtain initial access to the cell or enter a connected mode on the cell, and the minimum system information (specifically the RMSI indicated in SIB1) may include parameters for acquiring other system information (e.g., cell reselection information, intra-frequency and inter-frequency neighbor cells and reselection criteria, public warning system parameters, idle or inactive measurement configurations, and/or a sidelink communication configuration, among other examples) that is indicated in other SIBs (e.g., SIBs other than SIB1).

As shown by reference number 410, the network node 110 may transmit, and the UE 120 may receive, a MIB associated with the network node 110. In some aspects, the MIB is carried in a PBCH (within an SSB), and the MIB indicates various parameters associated with a cell provided by the network node 110, including an RMSI PDCCH configuration (e.g., indicated in a PDCCH-ConfigSIB1 parameter). In addition, the MIB may indicate parameters such as a system frame number, a subcarrier spacing, an SSB subcarrier offset (or k_SSB value), a position of a first downlink DMRS, an indication of whether intra-frequency reselection is allowed or not allowed, and a flag indicating whether access to the cell is barred or not barred.

As shown by reference number 420, and in cases where the barring flag in the MIB is set to zero (e.g., indicating that access to the cell is not barred), the network node 110 may transmit, and the UE 120 may receive, an RMSI PDCCH that schedules SIB1. For example, in some aspects, the UE 120 may use the RMSI PDCCH configuration indicated in the MIB to monitor for the RMSI PDCCH. For example, the MIB may indicate RMSI PDCCH parameters such as a bandwidth, a control resource set (CORESET), a common search space, and/or other suitable parameters associated with the RMSI PDCCH. Accordingly, the UE 120 may use the RMSI PDCCH configuration indicated in the MIB to monitor for and receive the RMSI PDCCH, which may indicate scheduling parameters for an RMSI PDSCH that carries SIB1. For example, in some aspects, the RMSI PDCCH may indicate parameters such as a frequency domain resource assignment (FDRA), a time domain resource assignment (TDRA), a virtual resource block to physical resource block (VRB-to-PRB) mapping, an MCS, a redundancy version, and/or a system information indicator (e.g., set to 0 to indicate that the RMSI PDCCH includes scheduling information for SIB1)

As shown by reference number 430, the network node 110 may transmit, and the UE 120 may receive, the RMSI PDSCH scheduled by the RMSI PDCCH, where the RMSI PDSCH carries data associated with SIB1. For example, in some aspects, the RMSI PDSCH may be transmitted by the network node 110 and received by the UE 120 according to the scheduling parameters indicated in the RMSI PDCCH. In some aspects, the RMSI PDSCH may carry SIB1, which may indicate parameters such as cell selection information, information related to cell access, a serving cell common configuration, one or more UE timers and/or constants, unified access control (UAC) barring information, and/or an idle mode measurement configuration, among other examples. In addition, SIB1 may include scheduling information for one or more other SIBs, which may include one or more SIBs that are periodically transmitted (broadcasted) and/or one or more SIBs that are transmitted on-demand. In some aspects, after acquiring SIB1, the UE 120 has acquired the minimum system information associated with the cell provided by the network node 110.

As shown by reference number 440, the network node 110 may transmit, and the UE 120 may receive, one or more periodic SIBs according to the system information scheduling information indicated in SIB1. For example, in some aspects, the UE 120 may identify one or more periodic SIBs that are transmitted by the network node 110 that are relevant to the UE 120 (e.g., the UE 120 may acquire a periodic SIB that carries a sidelink communication configuration to engage in sidelink communication, or may refrain from acquiring the periodic SIB that carries the sidelink communication configuration if the UE 120 is not engaging in sidelink communication). Accordingly, the UE 120 may optionally use the system information scheduling information in SIB1 to acquire only one or more SIBs that are relevant to the UE 120. Additionally, or alternatively, the network node 110 may transmit one or more periodic SIBs, or may transmit no periodic SIBs (e.g., all SIBs other than SIB1 are transmitted on-demand).

As shown by reference number 450, the UE 120 may transmit, and the network node 110 may receive, a request for one or more on-demand SIBs. For example, in some aspects, the system information scheduling information in SIB1 may indicate one or more SIBs that are transmitted only on-demand, and the UE 120 may optionally transmit the request only for one or more on-demand SIBs that are relevant to the UE 120. In such cases, as shown by reference number 460, the network node 110 may transmit, and the UE 120 may receive, the one or more on-demand SIBs requested by the UE 120. Additionally, or alternatively, the network node 110 may transmit one or more SIBs in an on-demand manner, or may transmit no on-demand SIBs (e.g., all SIBs other than SIB1 are transmitted periodically).

As indicated above, FIG. 4 is provided as an example. Other examples may differ from what is described with regard to FIG. 4.

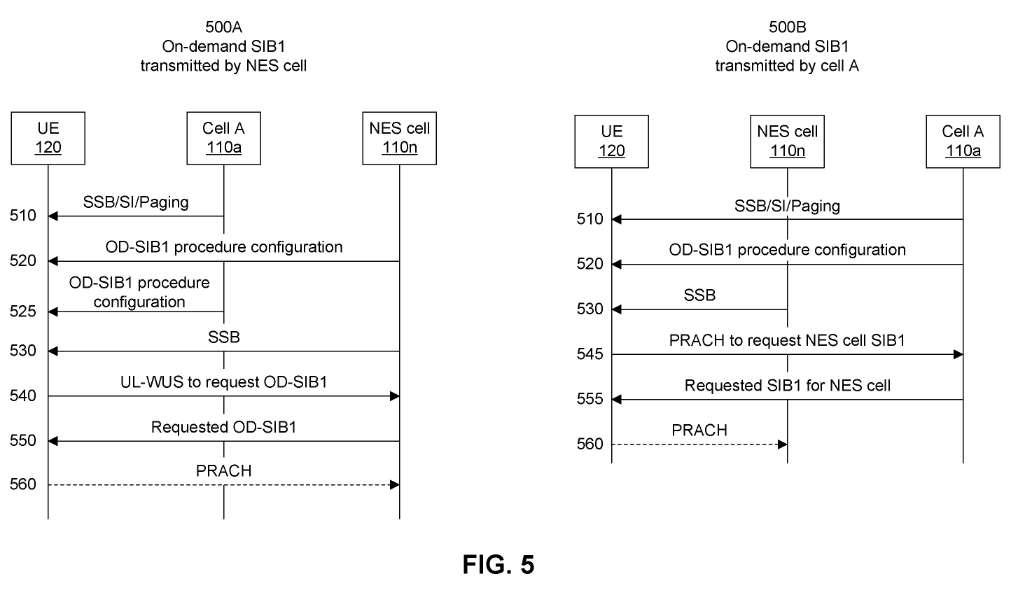

FIG. 5 is a diagram illustrating example call flows 500A and 500B for requesting and acquiring an on-demand SIB carrying RMSI for an NES cell. As shown in FIG. 5, example call flows 500A and 500B include communication between a UE 120, a neighbor or assisting cell 110a (shown as and referred to herein as “cell A”), and an NES cell 110n. For example, as described herein, cell A 110a is a cell that periodically transmits at least a SIB1 associated with cell A 110a, and the NES cell 110n is a cell that may transmit a SIB1 in an on-demand manner (e.g., in response to an UL-WUS from the UE 120, and/or in a limited number of SSB beam directions).

More particularly, as described herein, one technique to increase energy efficiency in a RAN is to enable “on-demand” broadcast transmissions by a network node and/or a cell. For example, to reduce power consumption at a network node, the network node may transmit certain broadcast communications (e.g., system information communications, SSBs, and/or SIBs) in an on-demand manner (e.g., upon request, rather than on a periodic basis or following a periodic schedule). In some examples, an on-demand communication may be a communication that carries RMSI, such as SIB1. In some examples, an SSB and/or SIB1 may include information to support initial access, measurement, camping, and/or cell selection or reselection by the UE 120. Typically, such communications are periodically broadcasted (e.g., following a periodic schedule where the communication(s) are transmitted one or more times, and often beamswept in multiple beam directions, in each period) so that the UE 120 can receive the communications in an idle and/or inactive state and/or upon moving into a geographic region of the NES cell 110n and establish a connection with the NES cell 110n. Therefore, one way to reduce network power consumption is to reduce transmissions of such communications such that, for example, an SSB and/or SIB1 is transmitted less frequently by a cell operating in an NES mode (or NES state).

For example, the NES cell 110n may operate in an NES mode or an NES state associated with an on-demand SIB1, where the SIB1 is transmitted only upon request by the UE 120, in order to reduce overhead and/or reduce power consumption. For example, the NES cell 110n may operate in the NES mode or the NES state associated with the on-demand SIB1 during periods with low activity (e.g., there are few UEs 120 entering and exiting the coverage of the cell, or there are not many UEs 120 that are attempting to establish a connection), in which case not periodically broadcasting SIB1 may conserve energy. In such cases, the SIB1 associated with the NES cell 110n may be broadcast only on-demand, or only upon request by the UE 120, where the request may be carried in an UL-WUS. For example, call flow 500A corresponds to two scenarios where an on-demand SIB1 associated with the NES cell 110n is transmitted by the NES cell 110n, and call flow 500B corresponds to a third scenario where the on-demand SIB1 associated with the NES cell 110n is transmitted by the cell A 110a.

For example, in a first scenario shown in call flow 500A, and by reference number 510, cell A 110a may transmit, and the UE 120 may receive, one or more SSBs, one or more system information messages, and/or one or more paging messages associated with cell A 110a (e.g., to acquire a SIB1 associated with cell A 110a). Furthermore, as shown by reference number 520 in call flow 500A, the NES cell 110n may transmit, and the UE 120 may receive, a message that indicates an on-demand SIB1 procedure configuration (e.g., indicating one or more parameters for requesting and acquiring the on-demand SIB1 associated with the NES cell 110n). For example, in some aspects, the on-demand SIB1 procedure configuration may include an UL-WUS configuration for the NES cell 110n, where the UL-WUS may be configured as a PRACH that includes a dedicated preamble reserved to requesting the on-demand SIB1 (e.g., distinct from PRACH preambles for the purpose of initial access). Accordingly, when the UE 120 detects and acquires an SSB from the NES cell 110n, as shown by reference number 530, the UE 120 may use the information in the on-demand SIB1 procedure configuration to request the on-demand SIB1 associated with the NES cell 110n. For example, as shown by reference number 540, the UE 120 may transmit a PRACH to request the on-demand SIB1 to the NES cell 110n. As shown by reference number 550 in call flow 500A, the NES cell 110n may then transmit the on-demand SIB1 in response to the PRACH transmitted by the UE 120. As shown by reference number 560, the UE 120 may then transmit a second PRACH to the NES cell 110n that includes a preamble associated with requesting initial access to the NES cell 110n (e.g., to enter a connected mode on the NES cell 110n).

In the first scenario shown in call flow 500A, the NES cell 110n acts as a source cell for providing the UL-WUS configuration to the UE 120 (e.g., in the on-demand SIB1 procedure configuration), acts as a target cell for receiving the UL-WUS transmission from the UE 120 (e.g., in the PRACH to request the on-demand SIB1 associated with the NES cell 110n), and acts as the source cell for transmitting the on-demand SIB1. Accordingly, in the first scenario shown in call flow 500A, cell A 110a periodically transmits the SSB, system information, and paging messages associated with cell A 110a and does not act as a source cell or a target cell for any messages that relate to the on-demand SIB1 associated with the NES cell 110n.

Alternatively, in the second scenario shown in call flow 500A, cell A 110a acts as the source cell for providing the UL-WUS configuration associated with the NES cell 110n to the UE 120. For example, as shown by reference number 525 in call flow 500A, cell A 110a may transmit the on-demand SIB1 procedure configuration to the UE 120, and other messages associated with requesting and acquiring the on-demand SIB1 associated with the NES cell 110n are the same as in the first scenario (e.g., where the NES cell 110n acts as the target cell for receiving the UL-WUS transmission from the UE 120 and as the source cell for transmitting the on-demand SIB1). In this way, relative to the first scenario, the NES cell 110n may conserve energy by not transmitting the on-demand SIB1 procedure configuration indicating the UL-WUS configuration.

Alternatively, in call flow 500B, cell A 110a acts as the source cell for providing the UL-WUS configuration associated with the NES cell 110n to the UE 120, as the target cell for receiving the UL-WUS transmission from the UE 120, and as the source cell for transmitting the on-demand SIB1 associated with the NES cell 110n. For example, as shown by reference number 545 in call flow 500B, the UE 120 may transmit the PRACH to request the on-demand SIB1 associated with the NES cell 110n to cell A 110a. Furthermore, as shown by reference number 555, cell A 110a may transmit the on-demand SIB1 associated with the NES cell 110n to the UE 120, and other messages associated with requesting and acquiring the on-demand SIB1 associated with the NES cell 110n are the same or similar as the second scenario shown in call flow 500A (e.g., where cell A 110a provides the on-demand SIB1 procedure configuration). In this way, relative to the second scenario shown in call flow 500A, the NES cell 110n may conserve energy by not having to monitor and/or process a PRACH transmission requesting the on-demand SIB1 and by not having to transmit the on-demand SIB1 that the UE 120 uses to request initial access.

As indicated above, FIG. 5 is provided as an example. Other examples may differ from what is described with regard to FIG. 5.

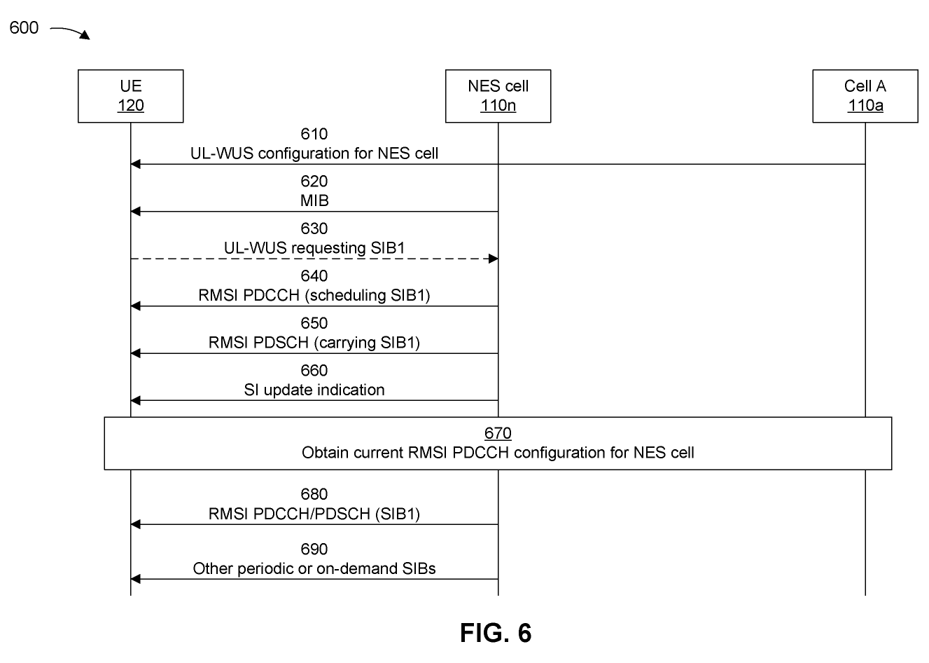

FIG. 6 is a diagram illustrating an example call flow 600 associated with on-demand system information and updated system information acquisition. As shown in FIG. 6, example 600 includes communication between an NES cell 110n and a UE 120. As described herein, the term “NES cell” (e.g., the NES cell 110n) refers to any suitable cell (or network node 110) operating in an NES mode (or NES state) associated with one or more techniques to reduce power consumption. In some aspects, the NES cell 110n may be associated with an unanchored deployment (e.g., where the NES cell 110n does not rely upon another cell to assist and/or control operations of the NES cell 110n). Alternatively, in some aspects, the NES cell 110n may be associated with an anchored deployment. For example, as shown in FIG. 6, example 600 may optionally include communication between the UE 120 and an anchor cell, neighbor cell, or assisting cell 110a, referred to as cell A 110a, where cell A 110a is configured to assist and/or control operations of the NES cell 110n. For example, cell A 110a may be a primary cell (PCell) and the NES cell 110n may be a secondary cell (SCell). For example, in carrier aggregation, the UE 120 may be configured with a primary carrier or PCell and one or more secondary carriers or SCells. In some aspects, the PCell may carry control information (e.g., downlink control information and/or scheduling information) for scheduling data communications on one or more SCells. Additionally, or alternatively, in an anchored deployment, cell A 110a may be a serving cell for the UE 120, and the NES cell 110n may be a neighbor cell for the UE 120. In some examples, the NES cell 110n and cell A 110a may be associated with (e.g., controlled by or supported by) the same network node 110. In other examples, the NES cell 110n and cell A 110a may be controlled by or supported by different network nodes 110.

In some aspects, as described herein, example 600 or one or more aspects or features described herein may be applied or applicable when the NES cell 110n communicates or operates in a given frequency range, frequency band, set of raster locations, and/or with a given SSB subcarrier spacing. Alternatively, example 600 or one or more aspects or features described herein may be applied or applicable regardless of a frequency range, frequency band, set of raster locations, and/or SSB subcarrier spacing associated with the NES cell 110n.

As described herein, the NES cell 110n may support an NES mode or NES state in which the NES cell 110n transmits SIB1, sometimes referred to as RMSI, in an on-demand manner to reduce power or otherwise conserve energy resources. For example, as described herein, the UE 120 may acquire minimum system information, including a MIB and SIB1, in order to connect to the NES cell 110n (e.g., to enter an RRC connected mode) and/or to camp on the NES cell 110n (e.g., in cases where the NES cell 110n supports camping). Accordingly, in some cases, the UE 120 may transmit an UL-WUS to the NES cell 110n while the UE 120 is in an idle mode or an inactive mode to request the on-demand SIB1 transmission (e.g., in order to camp on the cell, connect to the cell, or prepare to connect to the cell). In particular, the UE 120 may generally transmit the UL-WUS in an occasion when the cell is monitoring for the UL-WUS, such that the cell may transition to a more active state and transmit the on-demand SIB1 upon detecting the UL-WUS in a monitoring occasion. Furthermore, in cases where the UE 120 is attempting to connect to the NES cell 110n, the UE 120 may also need to transmit a msg1 or msgA preamble to initiate a RACH procedure in the NES cell 110n. Accordingly, the NES cell 110n may also need to monitor one or more occasions in which the UE 120 can transmit the msg1 or msgA preamble. In some aspects, as described herein, the NES cell 110n may support separate configurations and occasions for an UL-WUS and RACH msg1 or msgA preamble. Alternatively, one or more parameters and/or occasions may be shared among an UL-WUS configuration and a RACH msg1 or msgA preamble configuration.

In some aspects, as shown by reference number 610, cell A 110a may transmit, and the UE 120 may receive, information that indicates an UL-WUS configuration associated with the NES cell 110n. For example, in some aspects, the UL-WUS configuration may include various UL-WUS parameters, such as a subcarrier spacing, a timing advance offset, a time division duplexing (TDD) configuration, a position of one or more SSBs in a burst, a PBCH block power, or the like. In some cases, various UL-WUS parameters associated with the UL-WUS configuration may be fixed or otherwise defined (e.g., in a wireless communication standard), and the UL-WUS configuration may be transmitted in an SSB or other suitable signaling to indicate any remaining (e.g., configurable) UL-WUS parameters. Furthermore, in some aspects, the UL-WUS configuration may indicate a set of UL-WUS occasions (e.g., uplink resources in a frequency domain and/or a time domain) in which the UE 120 can transmit an UL-WUS, which may be separate from or shared with RACH occasions in which the UE 120 can transmit a RACH msg1 or a msgA preamble. In cases where the UL-WUS and RACH occasions are shared, the UL-WUS configuration may include one or more parameters to distinguish an UL-WUS from a msg1 or msgA transmission to initiate a RACH procedure (e.g., different preambles). In some aspects, the UL-WUS configuration may also indicate an RMSI PDCCH configuration that includes parameters for receiving an RMSI PDCCH that schedules an RMSI PDSCH carrying SIB1 associated with the NES cell 110n.

As shown by reference number 620, the NES cell 110n may transmit, and the UE 120 may receive, a MIB associated with the NES cell 110n. As described herein, the MIB associated with the NES cell 110n is carried in a PBCH (within an SSB transmitted by the NES cell 110n), and the MIB indicates various parameters associated with a cell provided by the NES cell 110n, such as a system frame number, a subcarrier spacing, a position of a first downlink DMRS, an indication of whether intra-frequency reselection is allowed or not allowed, and a flag indicating whether access to the cell is barred or not barred. In addition, the MIB may include an SSB subcarrier offset field, or k_SSB indication, which typically indicates a resource element (RE) or frequency domain offset between an SSB and a common resource block (RB) in an RB grid according to a number of subcarriers, and an RMSI PDCCH configuration field that typically indicates an RMSI PDCCH configuration. However, because the NES cell 110n supports an on-demand SIB1 transmission state, where SIB1 is transmitted only in response to an UL-WUS and/or transmitted only in a limited number of SSB beam directions, the information indicated in the SSB subcarrier offset field, referred to herein as the k_SSB field, and the RMSI PDCCH configuration in the MIB may vary depending on a current SIB1 transmission state associated with the NES cell 110n.

For example, as described herein, an NES cell 110n that supports an on-demand SIB1 transmission state may also support an always-on SIB1 transmission state. Accordingly, in some examples, the NES cell 110n may periodically broadcast SIB1 in a beam-swept manner over all transmitted SSB beam directions, or the NES cell 110n may operate according to an on-demand SIB1 transmission state where SIB1 is transmitted only in response to an UL-WUS, or transmitted only over a subset of SSB directions unless an UL-WUS is received. Furthermore, in some cases, the NES cell 110n may support a third SIB1 transmission state, which may be a SIB1-less state in which the NES cell 110n does not transmit SIB1 at all (even in response to an UL-WUS). Accordingly, when the UE 120 receives the UL-WUS configuration for the NES cell 110n (e.g., indicating the configuration for requesting an on-demand SIB1), the UE 120 may initially identify the current SIB1 transmission state for the NES cell 110n before attempting to acquire or request SIB1 (e.g., the UE 120 may check whether SIB1 is currently being broadcasted, provided on-demand, or not transmitted, before transmitting an UL-WUS to request SIB1 from the NES cell 110n).

Accordingly, in some aspects, the information indicated in the k_SSB field and/or the RMSI PDCCH configuration in the MIB associated with the NES cell 110n may vary depending on the SIB1 transmission state associated with the NES cell 110n. For example, the k_SSB field may have a value that is considered valid for communication in FR1 when the k_SSB value satisfies (e.g., is less than or equal to) a first threshold, or a value that is considered valid for communication in FR2 when the k_SSB value satisfies (e.g., is less than or equal to) a second threshold. For example, the k_SSB field may indicate a value that is less than or equal to 23 for communication in FR1, or may indicate a value that is less than or equal to 11 for communication in FR2. Accordingly, in some aspects, the current SIB1 transmission state may be the always-on SIB1 transmission state when the k_SSB field indicates a valid value (e.g., less than or equal to 23 for FR1, or less than or equal to 11 for FR2, indicating a CD-SSB) or the on-demand SIB1 transmission state when the k_SSB field indicates an invalid value (e.g., greater than 23 for FR1, or greater than 11 for FR2, indicating an NCD-SSB). In such cases, to avoid or minimize an impact to legacy UEs that do not support NES features such as an on-demand SIB1, legacy UEs may be barred from the NES cell 110n by a cell barring flag in the MIB and/or feature-specific barring bits in SIB1. Additionally, or alternatively, the UL-WUS configuration may include one or more barring indications based on using the k_SSB field to indicate the SIB1 transmission state. Furthermore, in cases where the k_SSB field indicates an invalid value, and the UL-WUS configuration provides the RMSI PDCCH configuration for the NES cell 110n, the bits in the MIB that are used to indicate the RMSI PDCCH configuration may be repurposed to indicate assistance information for locating a synchronization raster with a CD-SSB.

Additionally, or alternatively, the current SIB1 transmission state may be the always-on SIB1 transmission state when the k_SSB field indicates one or more specific values (e.g., a reserved value, such as 30 for FR1, or 14 for FR2) or the on-demand SIB1 transmission state when the k_SSB field indicates an invalid value other than the one or more specific values that indicate the always-on SIB1 transmission state (e.g., greater than 23 and not equal to 30 for FR1, or greater than 11 and not equal to 14 for FR2). In such cases, the bits in the MIB that are used to indicate the RMSI PDCCH configuration may be available to indicate other information. For example, in cases where a first set of k_SSB values indicate the always-on SIB1 transmission state and a second set of k_SSB values indicate the on-demand SIB1 transmission state, the RMSI PDCCH bits in the MIB may be used to indicate the RMSI PDCCH configuration or other information, such as a configuration related to the temporarily activated SIB1 transmission (e.g., a window, duration, periodicity, or other parameters associated with the temporarily activated SIB1 transmission). Alternatively, the bits in the MIB that are used to indicate the RMSI PDCCH configuration may be similarly repurposed to indicate assistance information for locating a synchronization raster with a CD-SSB (e.g., in cases where the encoded PBCH is used as an additional reference for tracking and/or receive beam switching).

Additionally, or alternatively, the k_SSB field may be set to a reserved or unused value (e.g., 30 for FR1 or 14 for FR2), in which case the current SIB1 transmission state may be indicated using one or more values or bits in the RMSI PDCCH field associated with the MIB. For example, the RMSI PDCCH field may include 8 bits, and one bit (e.g., a least significant bit (LSB) or most significant bit (MSB)) may indicate the current SIB1 transmission state or may be toggled to indicate a switch to the current SIB1 transmission state (e.g., in cases where the encoded PBCH is used as an additional reference for tracking and/or receive beam switching). Additionally, or alternatively, the 8 bits in the RMSI PDCCH field may indicate additional information about the UL-WUS configuration, additional information about the RMSI PDCCH configuration that is otherwise provided in the UL-WUS configuration, and/or additional information about cell A 110a. Additionally, or alternatively, the current SIB1 transmission state may be indicated using a reserved bit in the MIB, via the UL-WUS configuration, and/or via an indication in an RAR message.

In some aspects, in cases where the NES cell 110n supports a SIB1-less transmission state in addition to the always-on SIB1 transmission state and the on-demand SIB1 transmission state, one or more techniques described above may be similarly used to indicate that the NES cell 110n is operating in the SIB1-less transmission state or to indicate a switch to the SIB1-less transmission state from the always-on or on-demand SIB1 transmission state. For example, in some aspects, one or more k_SSB values (e.g., one or more invalid k_SSB values) may be used to indicate that the NES cell 110n is operating in the SIB1-less transmission state or to indicate a switch to the SIB1-less transmission state. In such cases, the MIB transmitted by the NES cell 110n may have a barring flag set to one (e.g., to bar access to the NES cell 110n while operating in the SIB1-less transmission state). Additionally, or alternatively, operation in the SIB1-less transmission state and/or a switch to the SIB1-less transmission state may be indicated via a short message (e.g., an extended short message to indicate the SIB1 transmission state), a PEI, a paging PDSCH, and/or an LP-WUS, among other examples. In some aspects, when operation in and/or a switch to the SIB1-less transmission state is indicated, the UE 120 may be implicitly aware that the NES cell 110n supports three SIB1 transmission states (e.g., the always-on SIB1 transmission state, the on-demand SIB1 transmission state, and the SIB1-less transmission state) based on the UL-WUS configuration (e.g., because the UL-WUS configuration indicates that the NES cell 110n supports the on-demand SIB1 transmission state, and cells that support the on-demand SIB1 transmission state also support operation in an always-on SIB1 transmission state). Additionally, or alternatively, when operation in and/or a switch to the SIB1-less transmission state is indicated, the UE 120 may be explicitly aware that the NES cell 110n supports three SIB1 transmission states based on an indication provided by the NES cell 110n or a neighbor cell, such as cell A 110a (e.g., as part of the UL-WUS configuration).

In some aspects, the UE 120 may attempt to acquire (or not acquire) SIB1 from the NES cell 110n according to the current SIB transmission state. For example, in cases where the NES cell 110n is operating in the SIB1-less transmission state, and the barring access flag in the MIB is set to one to bar access to the NES cell 110n, the UE 120 may refrain from attempting to acquire SIB1 from the NES cell 110n.

Alternatively, as shown by reference number 630, the UE 120 may transmit, and the NES cell 110n may receive, an UL-WUS to request SIB1 associated with the NES cell 110n in cases where the NES cell 110n is operating in the on-demand SIB1 transmission state (e.g., based on the k_SSB value in the MIB, one or more bits in the RMSI PDCCH configuration field in the MIB, a reserved bit in the MIB, the UL-WUS configuration, or the RAR indication). For example, the UL-WUS may be transmitted in an UL-WUS occasion using one or more parameters indicated in the UL-WUS configuration to request the on-demand SIB1. The UE 120 may then monitor for an RMSI PDCCH that schedules SIB1 associated with the NES cell 110n according to the UL-WUS configuration provided by cell A 110a. Alternatively, the UE 120 may refrain from transmitting any UL-WUS, and may monitor for the RMSI PDCCH that schedules SIB1 associated with the NES cell 110n in cases where the NES cell 110n is indicated to be operating in the always-on SIB1 transmission state (e.g., based on the k_SSB value in the MIB, one or more bits in the RMSI PDCCH configuration field in the MIB, a reserved bit in the MIB, the UL-WUS configuration, or the RAR indication).

Alternatively, in some aspects, there may be no indication to the UE 120 regarding the current SIB1 transmission state associated with the NES cell 110n, and the UE 120 may blindly monitor for the RMSI PDCCH that schedules SIB1 according to the RMSI PDCCH configuration indicated in the UL-WUS configuration. In this case, the UE 120 may determine that the NES cell 110n is operating in the always-on SIB1 transmission state if the RMSI PDCCH is received within a threshold time period, or may determine that the NES cell 110n is operating in the on-demand SIB1 transmission state if the RMSI PDCCH is not received within the threshold time period. In the latter case, where the UE 120 determines that the NES cell 110n is operating in the on-demand SIB1 transmission state based on a failure to receive the RMSI PDCCH within the threshold time period, the UE 120 may transmit the UL-WUS to request the on-demand SIB1 transmission.

As shown by reference number 640, in either the always-on SIB1 transmission state or the on-demand SIB1 transmission state, the NES cell 110n may transmit, and the UE 120 may receive, an RMSI PDCCH that schedules SIB1. For example, in some aspects, the UE 120 may use the RMSI PDCCH configuration indicated in the UL-WUS configuration to monitor for the RMSI PDCCH. For example, the UL-WUS configuration may indicate RMSI PDCCH parameters such as a bandwidth, a CORESET, a common search space, and/or other suitable parameters associated with the RMSI PDCCH. Accordingly, the UE 120 may use the RMSI PDCCH configuration indicated in the UL-WUS configuration to monitor for and receive the RMSI PDCCH, which may indicate scheduling parameters for an RMSI PDSCH that carries the on-demand SIB1. For example, in some aspects, the RMSI PDCCH may indicate parameters such as an FDRA, a TDRA, a VRB-to-PRB mapping, an MCS, a redundancy version, and/or a system information indicator (e.g., set to 0 to indicate that the RMSI PDCCH includes scheduling information for SIB1).

As shown by reference number 650, the NES cell 110n may transmit, and the UE 120 may receive, the RMSI PDSCH scheduled by the RMSI PDCCH, where the RMSI PDSCH carries data associated with SIB1. For example, in some aspects, the RMSI PDSCH may be transmitted by the NES cell 110n and received by the UE 120 according to the scheduling parameters indicated in the RMSI PDCCH. In some aspects, the RMSI PDSCH may carry SIB1, which may indicate parameters such as cell selection information, information related to cell access, a serving cell common configuration, one or more UE timers and/or constants, UAC barring information, and/or an idle mode measurement configuration, among other examples. In addition, SIB1 may include scheduling information for one or more other SIBs, which may include one or more SIBs that are periodically broadcasted and/or one or more SIBs transmitted on-demand. In some aspects, after acquiring the on-demand SIB1, the UE 120 has acquired the minimum system information associated with the NES cell 110n. Furthermore, in some aspects, the UE 120 may subsequently acquire other system information (e.g., in one or more periodically broadcasted SIBs and/or on-demand SIBs) associated with the NES cell 110n in a similar manner as described above for FIG. 4.

In some aspects, in cases where the NES cell 110n is operating in the on-demand SIB1 transmission state, the UE 120 may be provided with an indication of spatial information for receiving the RMSI PDCCH that schedules the on-demand SIB1 and/or the RMSI PDSCH that carries the on-demand SIB1. In some aspects, the spatial information for receiving the RMSI PDCCH and/or the RMSI PDSCH may be indicated in the UL-WUS configuration and/or an RAR message. For example, in some aspects, the spatial information may indicate a spatial transmission scheme for the on-demand SIB1 transmission, such as a spatial transmission scheme in which the on-demand SIB1 is transmitted using the SSB beam associated with the UL-WUS transmission from the UE 120 or a spatial transmission scheme in which the on-demand SIB1 is transmitted using all SSB beams associated with the NES cell 110n. Additionally, or alternatively, the spatial information may indicate one or more SSB beams or a subset of SSB beams used to transmit the on-demand SIB1, such as the SSB beam associated with the UL-WUS transmission from the UE 120 and one or more SSBs beams neighboring the SSB beam associated with the UL-WUS transmission.

In some aspects, after the UE 120 has acquired the minimum system information associated with the NES cell 110n and any other system information carried in one or more SIBs based on scheduling information indicated in the SIB1 associated with the NES cell 110n, the UE 120 may perform a RACH procedure with the NES cell 110n to enter a connected mode or may camp on the NES cell 110n in an idle or inactive mode. In some aspects, as shown by reference number 660, the NES cell 110n may transmit, and the UE 120 may receive, an indication to update the system information associated with the NES cell 110n in accordance with one or more changes to the system information associated with the NES cell 110n. For example, in some aspects, the system information may be updated to change the RMSI PDCCH configuration, or to change any other system information that may be indicated in SIB1 and/or one or more other SIBs. Accordingly, as shown by reference number 670, the UE 120 may obtain the current RMSI PDCCH configuration for the NES cell 110n, which may be performed based on local operations at the UE 120 and/or via communication with one or more of the NES cell 110n or cell A 110a.

For example, in some aspects, the UE 120 may obtain the current RMSI PDCCH configuration for the NES cell 110n by reacquiring the MIB associated with the NES cell 110n and identifying the k_SSB value indicated in the MIB. In general, when the k_SSB value indicated in the MIB is an invalid value (e.g., greater than 23 for FR1 or greater than 11 for FR2), the RMSI PDCCH bits in the MIB may be repurposed or reinterpreted to indicate synchronization raster assistance information or other suitable information (other than an RMSI PDCCH configuration). In such cases, the RMSI PDCCH configuration is provided by the UL-WUS configuration, which the UE 120 may be unable to obtain because the UE 120 is connected to and/or camping on the NES cell 110n. Accordingly, in some aspects, the k_SSB may indicate a designated invalid value (e.g., a reserved or unused k_SSB value, such as 30 for FR1 or 14 for FR2) to indicate that the NES cell 110n supports an on-demand SIB1. In such cases, when the k_SSB may indicate a designated invalid value, the RMSI PDCCH bits may be used to indicate the RMSI PDCCH configuration for the NES cell 110n (e.g., rather than synchronization raster assistance information or other information). Furthermore, in cases where the current RMSI PDCCH configuration is indicated in the RMSI PDCCH field of the MIB, the UE 120 may assume that a previously configured or indicated k_SSB value (e.g., that was valid and in effect for the NES cell 110n prior to the system information update notification) remains unchanged and in effect after the system information update notification. For example, the valid k_SSB value for the NES cell 110n may be defined in a wireless communication standard, or configured or indicated to the UE 120 by the NES cell 110n or a neighbor cell, such as cell A 110a.

Additionally, or alternatively, when the UE 120 receives the updated system information notification, the UE 120 may assume that the RMSI PDCCH configuration that was previously configured or indicated (e.g., in the UL-WUS configuration) and in effect for the NES cell 110n prior to the system information update notification remains unchanged and in effect after the system information update notification. In other words, the current RMSI PDCCH configuration after the system information update notification is the same as the RMSI PDCCH configuration prior to the system information update notification. For example, the previous RMSI PDCCH configuration may remain unchanged based on one or more rules defined in a wireless communication standard, or based on one or more parameters configured or indicated to the UE 120 by the NES cell 110n or a neighbor cell, such as cell A 110a.

Additionally, or alternatively, when the UE 120 receives the updated system information notification, the UE 120 may blindly monitor for the RMSI PDCCH using the RMSI PDCCH configuration that was configured or indicated (e.g., in the UL-WUS configuration) prior to the system information update notification. In cases where the RMSI PDCCH configuration has not changed, the UE 120 will receive the RMSI PDCCH scheduling SIB1 associated with the NES cell 110n and acquire the updated system information accordingly. Alternatively, in cases where the RMSI PDCCH configuration has changed, the UE 120 will fail to receive the RMSI PDCCH. In this case, where the UE 120 fails to acquire the RMSI or other updated system information, the UE 120 may return to cell A 110a to acquire an updated UL-WUS configuration for the NES cell 110n, where the updated UL-WUS configuration may indicate the current RMSI PDCCH configuration for the NES cell 110n. The UE 120 may then confirm that the UE 120 is still permitted to select and camp on the NES cell 110n (e.g., based on any cell barring information or other parameters in the UL-WUS configuration and/or MIB), and may reselect the NES cell 110n based on a confirmation that the UE 120 is still permitted to select and camp on the NES cell 110n (e.g., after optionally transmitting an UL-WUS to the NES cell 110n).

Additionally, or alternatively, when the UE 120 receives an indication that the system information associated with the NES cell 110n has been updated, the NES cell 110n (or another suitable cell, such as cell A 110a) may transmit a message to the UE 120 indicating whether the RMSI PDCCH configuration has changed and/or indicating whether the UL-WUS configuration (that indicates the RMSI PDCCH configuration) has changed. For example, the message indicating whether the RMSI PDCCH and/or UL-WUS configuration has changed may be provided in a short message, a PEI, a paging PDSCH, an LP-WUS, and/or another suitable signal or message. In cases where the RMSI PDCCH and/or UL-WUS configuration has not changed, the UE 120 may attempt to monitor for and receive the RMSI PDCCH using the current (unchanged) RMSI PDCCH configuration and acquire the updated system information accordingly. Alternatively, in cases where the RMSI PDCCH and/or UL-WUS configuration has changed, the UE 120 may tune to another cell, such as cell A 110a, to acquire an updated UL-WUS configuration for the NES cell 110n, where the updated UL-WUS configuration may indicate the current RMSI PDCCH configuration for the NES cell 110n. The UE 120 may then reselect the NES cell 110n and transmit an UL-WUS to the NES cell 110n to request and acquire the updated system information. In addition, in cases where the RMSI PDCCH configuration has changed, the NES cell 110n may operate in the on-demand SIB1 transmission state for at least a few cycles (e.g., the NES cell 110n does not proactively transmit updated RMSI and/or other system information).

As shown by reference number 680, the NES cell 110n may transmit, and the UE 120 may receive, SIB1. For example, in some aspects, the UE 120 may use the current RMSI PDCCH configuration (e.g., obtained using one or more techniques described above) to monitor for an RMSI PDCCH scheduling SIB1 associated with the NES cell 110n. Accordingly, the UE 120 may use the current RMSI PDCCH configuration to monitor for and receive the RMSI PDCCH, which may indicate scheduling parameters for an RMSI PDSCH that carries SIB1 associated with the NES cell 110n. The NES cell 110n may then transmit, and the UE 120 may receive, the RMSI PDSCH scheduled by the RMSI PDCCH, where the RMSI PDSCH carries data associated with SIB1. For example, in some aspects, the RMSI PDSCH may be transmitted by the NES cell 110n and received by the UE 120 according to the scheduling parameters indicated in the RMSI PDCCH. In addition, SIB1 may include scheduling information for one or more other SIBs, which may include one or more SIBs that are periodically broadcasted and/or one or more SIBs transmitted on-demand. Accordingly, as shown by reference 690, after reacquiring SIB1, the UE 120 may acquire other system information (e.g., in one or more periodically broadcasted SIBs and/or on-demand SIBs) associated with the NES cell 110n using system information scheduling information indicated in the reacquired SIB1. In this way, the UE 120 may obtain and apply the current RMSI PDCCH configuration to acquire the updated (most current) system information associated with the NES cell 110n.

As indicated above, FIG. 6 is provided as an example. Other examples may differ from what is described with regard to FIG. 6.

FIG. 7 is a diagram illustrating an example process 700 performed, for example, at a UE or an apparatus of a UE. Example process 700 is an example where the apparatus or the UE (e.g., UE 120) performs operations associated with on-demand system information and updated system information acquisition.

As shown in FIG. 7, in some aspects, process 700 may include receiving, from an NES cell, an indication to acquire updated system information associated with the NES cell (block 710). For example, the UE (e.g., using reception component 902 and/or communication manager 906, depicted in FIG. 9) may receive, from an NES cell, an indication to acquire updated system information associated with the NES cell, as described above.

As further shown in FIG. 7, in some aspects, process 700 may include obtaining a current RMSI PDCCH configuration associated with the NES cell (block 720). For example, the UE (e.g., using reception component 902 and/or communication manager 906, depicted in FIG. 9) may obtain a current RMSI PDCCH configuration associated with the NES cell, as described above.

As further shown in FIG. 7, in some aspects, process 700 may include acquiring, from the NES cell, the updated system information in accordance with the current RMSI PDCCH configuration (block 730). For example, the UE (e.g., using communication manager 906, depicted in FIG. 9) may acquire, from the NES cell, the updated system information in accordance with the current RMSI PDCCH configuration, as described above.

Process 700 may include additional aspects, such as any single aspect or any combination of aspects described below and/or in connection with one or more other processes described elsewhere herein.

In a first aspect, process 700 includes receiving, from the NES cell, a MIB indicating an invalid SSB RE offset, wherein a valid SSB RE offset for the NES cell is unchanged based on the invalid SSB RE offset indicating support for an on-demand SIB, and obtaining the current RMSI PDCCH configuration from the MIB based on the invalid SSB RE offset indicating support for the on-demand SIB.

In a second aspect, alone or in combination with the first aspect, the current RMSI PDCCH configuration is unchanged from an RMSI PDCCH configuration in effect for the NES cell prior to the indication to acquire the updated system information associated with the NES cell.

In a third aspect, alone or in combination with one or more of the first and second aspects, process 700 includes monitoring for an RMSI PDCCH associated with an RMSI PDCCH configuration in effect for the NES cell prior to the indication to acquire the updated system information, and acquiring, from a neighbor cell, the current RMSI PDCCH configuration associated with the NES cell in accordance with a failure to detect the RMSI PDCCH associated with the RMSI PDCCH configuration in effect for the NES cell prior to the indication to acquire the updated system information.

In a fourth aspect, alone or in combination with one or more of the first through third aspects, process 700 includes receiving an indication that the current RMSI PDCCH configuration is unchanged from an RMSI PDCCH configuration in effect for the NES cell prior to the indication to acquire the updated system information associated with the NES cell.

In a fifth aspect, alone or in combination with one or more of the first through fourth aspects, process 700 includes receiving an indication that the current RMSI PDCCH configuration has changed from an RMSI PDCCH configuration in effect for the NES cell prior to the indication to acquire the updated system information associated with the NES cell, and acquiring, from a neighbor cell, the current RMSI PDCCH configuration associated with the NES cell in accordance with the indication that the current RMSI PDCCH configuration has changed.

In a sixth aspect, alone or in combination with one or more of the first through fifth aspects, the updated system information is acquired in accordance with the current RMSI PDCCH configuration based on one or more of a frequency range, a frequency band, one or more raster locations, or an SSB subcarrier spacing associated with the NES cell.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE. Example process 800 is an example where the apparatus or the UE (e.g., UE 120) performs operations associated with on-demand system information and updated system information acquisition.

As shown in FIG. 8, in some aspects, process 800 may include receiving, from a neighbor cell, an UL-WUS configuration associated with an NES cell (block 810). For example, the UE (e.g., using reception component 902 and/or communication manager 906, depicted in FIG. 9) may receive, from a neighbor cell, an UL-WUS configuration associated with an NES cell, as described above.

As further shown in FIG. 8, in some aspects, process 800 may include identifying a current SIB transmission mode associated with the NES cell in accordance with the UL-WUS configuration indicating that the NES cell supports at least an on-demand SIB mode and an always-on SIB mode (block 820). For example, the UE (e.g., using communication manager 906, depicted in FIG. 9) may identify a current SIB transmission mode associated with the NES cell in accordance with the UL-WUS configuration indicating that the NES cell supports at least an on-demand SIB mode and an always-on SIB mode, as described above.

As further shown in FIG. 8, in some aspects, process 800 may include acquiring, from the NES cell, system information associated with the NES cell in accordance with the current SIB transmission mode associated with the NES cell (block 830). For example, the UE (e.g., using communication manager 906, depicted in FIG. 9) may acquire, from the NES cell, system information associated with the NES cell in accordance with the current SIB transmission mode associated with the NES cell, as described above.

Process 800 may include additional aspects, such as any single aspect or any combination of aspects described below and/or in connection with one or more other processes described elsewhere herein.

In a first aspect, process 800 includes receiving, from the NES cell, an indication that the current SIB transmission mode is a SIB-less mode.

In a second aspect, alone or in combination with the first aspect, the indication is received in a MIB that indicates an invalid SSB RE offset and bars access to the NES cell.

In a third aspect, alone or in combination with one or more of the first and second aspects, the indication is received in a short message, a PEI, a paging PDSCH, or an LP-WUS.

In a fourth aspect, alone or in combination with one or more of the first through third aspects, process 800 includes determining that the NES cell supports switching between the on-demand SIB mode, the always-on SIB mode, and the SIB-less mode in accordance with the UL-WUS configuration associated with the NES cell.

In a fifth aspect, alone or in combination with one or more of the first through fourth aspects, process 800 includes receiving an indication that the NES cell supports switching between the on-demand SIB mode, the always-on SIB mode, and the SIB-less mode.

In a sixth aspect, alone or in combination with one or more of the first through fifth aspects, acquiring the system information associated with the NES cell includes receiving a SIB transmission from the NES cell in accordance with the current SIB transmission mode being the on-demand SIB mode or the always-on SIB mode, wherein the SIB transmission received from the NES cell includes at least a portion of the system information associated with the NES cell.

In a seventh aspect, alone or in combination with one or more of the first through sixth aspects, acquiring the system information associated with the NES cell includes transmitting, to the NES cell, an UL-WUS to request the SIB transmission in accordance with the current SIB transmission mode being the on-demand SIB mode.

In an eighth aspect, alone or in combination with one or more of the first through seventh aspects, process 800 includes receiving a spatial indication associated with the SIB transmission, wherein the SIB transmission is received in accordance with the spatial indication.

In a ninth aspect, alone or in combination with one or more of the first through eighth aspects, the spatial indication associates the SIB transmission with an SSB beam used to transmit the UL-WUS.

In a tenth aspect, alone or in combination with one or more of the first through ninth aspects, the spatial indication associates the SIB transmission with all SSB beams associated with the NES cell.

In an eleventh aspect, alone or in combination with one or more of the first through tenth aspects, the spatial indication associates the SIB transmission with an SSB beam used to transmit the UL-WUS and one or more SSB beams neighboring the SSB beam used to transmit the UL-WUS.

In a twelfth aspect, alone or in combination with one or more of the first through eleventh aspects, identifying the current SIB transmission mode includes monitoring for a SIB transmission from the NES cell, wherein the current SIB transmission mode is the always-on SIB mode in accordance with receiving the SIB transmission within a time period, or the on-demand SIB mode in accordance with a failure to receive the SIB transmission within the time period.

In a thirteenth aspect, alone or in combination with one or more of the first through twelfth aspects, identifying the current SIB transmission mode includes receiving, from the NES cell, a MIB indicating the current SIB transmission mode.

In a fourteenth aspect, alone or in combination with one or more of the first through thirteenth aspects, the MIB indicates an SSB RE offset and the current SIB transmission mode is the always-on SIB mode in accordance with a first set of SSB RE offsets including the SSB RE offset indicated in the MIB, or the on-demand SIB mode in accordance with a second set of SSB RE offsets including the SSB RE offset indicated in the MIB.

In a fifteenth aspect, alone or in combination with one or more of the first through fourteenth aspects, the MIB includes a SIB PDCCH configuration indicating the current SIB transmission mode.

In a sixteenth aspect, alone or in combination with one or more of the first through fifteenth aspects, the MIB includes one or more bits indicating the current SIB transmission mode.

In a seventeenth aspect, alone or in combination with one or more of the first through sixteenth aspects, the UL-WUS configuration indicates the current SIB transmission mode.

In an eighteenth aspect, alone or in combination with one or more of the first through seventeenth aspects, identifying the current SIB transmission mode includes receiving, from the NES cell, a random access response (RAR) message indicating the current SIB transmission mode.

In a nineteenth aspect, alone or in combination with one or more of the first through eighteenth aspects, the current SIB transmission mode is identified in accordance with the UL-WUS configuration based on one or more of a frequency range, a frequency band, one or more raster locations, or an SSB subcarrier spacing associated with the NES cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from an NES cell, an indication to acquire updated system information associated with the NES cell. The reception component 902 may obtain a current RMSI PDCCH configuration associated with the NES cell. The communication manager 906 may acquire, from the NES cell, the updated system information in accordance with the current RMSI PDCCH configuration.

The reception component 902 may receive, from the NES cell, a MIB indicating an invalid SSB RE offset, wherein a valid SSB RE offset for the NES cell is unchanged based on the invalid SSB RE offset indicating support for an on-demand SIB. The reception component 902 may obtain the current RMSI PDCCH configuration from the MIB based on the invalid SSB RE offset indicating support for the on-demand SIB.

The communication manager 906 may monitor for an RMSI PDCCH associated with an RMSI PDCCH configuration in effect for the NES cell prior to the indication to acquire the updated system information. The communication manager 906 may acquire, from a neighbor cell, the current RMSI PDCCH configuration associated with the NES cell in accordance with a failure to detect the RMSI PDCCH associated with the RMSI PDCCH configuration in effect for the NES cell prior to the indication to acquire the updated system information.

The reception component 902 may receive an indication that the current RMSI PDCCH configuration is unchanged from an RMSI PDCCH configuration in effect for the NES cell prior to the indication to acquire the updated system information associated with the NES cell.

The reception component 902 may receive an indication that the current RMSI PDCCH configuration has changed from an RMSI PDCCH configuration in effect for the NES cell prior to the indication to acquire the updated system information associated with the NES cell. The communication manager 906 may acquire, from a neighbor cell, the current RMSI PDCCH configuration associated with the NES cell in accordance with the indication that the current RMSI PDCCH configuration has changed.

The reception component 902 may receive, from a neighbor cell, an UL-WUS configuration associated with an NES cell. The communication manager 906 may identify a current SIB transmission mode associated with the NES cell in accordance with the UL-WUS configuration indicating that the NES cell supports at least an on-demand SIB mode and an always-on SIB mode. The communication manager 906 may acquire, from the NES cell, system information associated with the NES cell in accordance with the current SIB transmission mode associated with the NES cell.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving, from an NES cell, an indication to acquire updated system information associated with the NES cell; obtaining a current RMSI PDCCH configuration associated with the NES cell; and acquiring, from the NES cell, the updated system information in accordance with the current RMSI PDCCH configuration.

Aspect 2: The method of Aspect 1, further comprising: receiving, from the NES cell, a MIB indicating an invalid SSB RE offset, wherein a valid SSB RE offset for the NES cell is unchanged based on the invalid SSB RE offset indicating support for an on-demand SIB; and obtaining the current RMSI PDCCH configuration from the MIB based on the invalid SSB RE offset indicating support for the on-demand SIB.

Aspect 3: The method of any of Aspects 1-2, wherein the current RMSI PDCCH configuration is unchanged from an RMSI PDCCH configuration in effect for the NES cell prior to the indication to acquire the updated system information associated with the NES cell.

Aspect 4: The method of any of Aspects 1-3, further comprising: monitoring for an RMSI PDCCH associated with an RMSI PDCCH configuration in effect for the NES cell prior to the indication to acquire the updated system information; and acquiring, from a neighbor cell, the current RMSI PDCCH configuration associated with the NES cell in accordance with a failure to detect the RMSI PDCCH associated with the RMSI PDCCH configuration in effect for the NES cell prior to the indication to acquire the updated system information.

Aspect 5: The method of any of Aspects 1-4, further comprising: receiving an indication that the current RMSI PDCCH configuration is unchanged from an RMSI PDCCH configuration in effect for the NES cell prior to the indication to acquire the updated system information associated with the NES cell.

Aspect 6: The method of any of Aspects 1-5, further comprising: receiving an indication that the current RMSI PDCCH configuration has changed from an RMSI PDCCH configuration in effect for the NES cell prior to the indication to acquire the updated system information associated with the NES cell; and acquiring, from a neighbor cell, the current RMSI PDCCH configuration associated with the NES cell in accordance with the indication that the current RMSI PDCCH configuration has changed.

Aspect 7: The method of any of Aspects 1-6, wherein the updated system information is acquired in accordance with the current RMSI PDCCH configuration based on one or more of a frequency range, a frequency band, one or more raster locations, or an SSB subcarrier spacing associated with the NES cell.

Aspect 8: A method of wireless communication performed by a UE, comprising: receiving, from a neighbor cell, an UL-WUS configuration associated with an NES cell; identifying a current SIB transmission mode associated with the NES cell in accordance with the UL-WUS configuration indicating that the NES cell supports at least an on-demand SIB mode and an always-on SIB mode; and acquiring, from the NES cell, system information associated with the NES cell in accordance with the current SIB transmission mode associated with the NES cell.

Aspect 9: The method of Aspect 8, further comprising: receiving, from the NES cell, an indication that the current SIB transmission mode is a SIB-less mode.

Aspect 10: The method of Aspect 9, wherein the indication is received in a MIB that indicates an invalid SSB RE offset and bars access to the NES cell.

Aspect 11: The method of Aspect 9, wherein the indication is received in a short message, a PEI, a paging PDSCH, or an LP-WUS.

Aspect 12: The method of Aspect 9, further comprising: determining that the NES cell supports switching between the on-demand SIB mode, the always-on SIB mode, and the SIB-less mode in accordance with the UL-WUS configuration associated with the NES cell.

Aspect 13: The method of Aspect 9, further comprising: receiving an indication that the NES cell supports switching between the on-demand SIB mode, the always-on SIB mode, and the SIB-less mode.

Aspect 14: The method of any of Aspects 8-13, wherein acquiring the system information associated with the NES cell includes: receiving a SIB transmission from the NES cell in accordance with the current SIB transmission mode being the on-demand SIB mode or the always-on SIB mode, wherein the SIB transmission received from the NES cell includes at least a portion of the system information associated with the NES cell.

Aspect 15: The method of Aspect 14, wherein acquiring the system information associated with the NES cell includes: transmitting, to the NES cell, an UL-WUS to request the SIB transmission in accordance with the current SIB transmission mode being the on-demand SIB mode.

Aspect 16: The method of Aspect 15, further comprising: receiving a spatial indication associated with the SIB transmission, wherein the SIB transmission is received in accordance with the spatial indication.

Aspect 17: The method of Aspect 16, wherein the spatial indication associates the SIB transmission with an SSB beam used to transmit the UL-WUS.

Aspect 18: The method of Aspect 16, wherein the spatial indication associates the SIB transmission with all SSB beams associated with the NES cell.

Aspect 19: The method of Aspect 16, wherein the spatial indication associates the SIB transmission with an SSB beam used to transmit the UL-WUS and one or more SSB beams neighboring the SSB beam used to transmit the UL-WUS.

Aspect 20: The method of any of Aspects 8-19, wherein identifying the current SIB transmission mode includes: monitoring for a SIB transmission from the NES cell, wherein the current SIB transmission mode is: the always-on SIB mode in accordance with receiving the SIB transmission within a time period, or the on-demand SIB mode in accordance with a failure to receive the SIB transmission within the time period.

Aspect 21: The method of any of Aspects 8-20, wherein identifying the current SIB transmission mode includes: receiving, from the NES cell, a MIB indicating the current SIB transmission mode.

Aspect 22: The method of Aspect 21, wherein the MIB indicates an SSB RE offset and the current SIB transmission mode is: the always-on SIB mode in accordance with a first set of SSB RE offsets including the SSB RE offset indicated in the MIB, or the on-demand SIB mode in accordance with a second set of SSB RE offsets including the SSB RE offset indicated in the MIB.

Aspect 23: The method of Aspect 21, wherein the MIB includes a SIB PDCCH configuration indicating the current SIB transmission mode.

Aspect 24: The method of Aspect 21, wherein the MIB includes one or more bits indicating the current SIB transmission mode.

Aspect 25: The method of any of Aspects 8-24, wherein the UL-WUS configuration indicates the current SIB transmission mode.

Aspect 26: The method of any of Aspects 8-25, wherein identifying the current SIB transmission mode includes: receiving, from the NES cell, a random access response (RAR) message indicating the current SIB transmission mode.

Aspect 27: The method of any of Aspects 8-26, wherein the current SIB transmission mode is identified in accordance with the UL-WUS configuration based on one or more of a frequency range, a frequency band, one or more raster locations, or an SSB subcarrier spacing associated with the NES cell.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network energy savings (NES) cell, an indication to acquire updated system information associated with the NES cell;
obtain a current remaining minimum system information (RMSI) physical downlink control channel (PDCCH) configuration associated with the NES cell; and
acquire, from the NES cell, the updated system information in accordance with the current RMSI PDCCH configuration.

2. The UE of claim 1, wherein the one or more processors are further configured to cause the UE to:
receive, from the NES cell, a master information block (MIB) indicating an invalid synchronization signal block (SSB) resource element (RE) offset, wherein a valid SSB RE offset for the NES cell is unchanged based on the invalid SSB RE offset indicating support for an on-demand system information block (SIB); and
obtain the current RMSI PDCCH configuration from the MIB based on the invalid SSB RE offset indicating support for the on-demand SIB.

3. The UE of claim 1, wherein the current RMSI PDCCH configuration is unchanged from an RMSI PDCCH configuration in effect for the NES cell prior to the indication to acquire the updated system information associated with the NES cell.

4. The UE of claim 1, wherein the one or more processors are further configured to cause the UE to:
monitor for an RMSI PDCCH associated with an RMSI PDCCH configuration in effect for the NES cell prior to the indication to acquire the updated system information; and
acquire, from a neighbor cell, the current RMSI PDCCH configuration associated with the NES cell in accordance with a failure to detect the RMSI PDCCH associated with the RMSI PDCCH configuration in effect for the NES cell prior to the indication to acquire the updated system information.

5. The UE of claim 1, wherein the one or more processors are further configured to cause the UE to:
receive an indication that the current RMSI PDCCH configuration is unchanged from an RMSI PDCCH configuration in effect for the NES cell prior to the indication to acquire the updated system information associated with the NES cell.

6. The UE of claim 1, wherein the one or more processors are further configured to cause the UE to:
receive an indication that the current RMSI PDCCH configuration has changed from an RMSI PDCCH configuration in effect for the NES cell prior to the indication to acquire the updated system information associated with the NES cell; and
acquire, from a neighbor cell, the current RMSI PDCCH configuration associated with the NES cell in accordance with the indication that the current RMSI PDCCH configuration has changed.

7. A user equipment (UE) for wireless communication, comprising:
one or more memories; and
one or more processors, coupled to the one or more memories, configured to cause the UE to:
receive, from a neighbor cell, an uplink wakeup signal (UL-WUS) configuration associated with a network energy savings (NES) cell;
identify a current system information block (SIB) transmission mode associated with the NES cell in accordance with the UL-WUS configuration indicating that the NES cell supports at least an on-demand SIB mode and an always-on SIB mode; and
acquire, from the NES cell, system information associated with the NES cell in accordance with the current SIB transmission mode associated with the NES cell.

8. The UE of claim 7, wherein the one or more processors are further configured to cause the UE to:
receive, from the NES cell, an indication that the current SIB transmission mode is a SIB-less mode.

9. The UE of claim 8, wherein the indication is received in a short message, a paging early indicator (PEI), a paging physical downlink shared channel (PDSCH), or a low power wakeup signal (LP-WUS), or a master information block (MIB) that indicates an invalid synchronization signal block (SSB) resource element (RE) offset and bars access to the NES cell.

10. The UE of claim 8, wherein the one or more processors are further configured to cause the UE to:
determine that the NES cell supports switching between the on-demand SIB mode, the always-on SIB mode, and the SIB-less mode in accordance with the UL-WUS configuration associated with the NES cell.

11. The UE of claim 8, wherein the one or more processors are further configured to cause the UE to:
receive an indication that the NES cell supports switching between the on-demand SIB mode, the always-on SIB mode, and the SIB-less mode.

12. The UE of claim 7, wherein the one or more processors, to cause the UE to acquire the system information associated with the NES cell, are configured to cause the UE to:
receive a SIB transmission from the NES cell in accordance with the current SIB transmission mode being the on-demand SIB mode or the always-on SIB mode, wherein the SIB transmission received from the NES cell includes at least a portion of the system information associated with the NES cell.

13. The UE of claim 12, wherein the one or more processors, to cause the UE to acquire the system information associated with the NES cell, are configured to cause the UE to:
transmit, to the NES cell, an UL-WUS to request the SIB transmission in accordance with the current SIB transmission mode being the on-demand SIB mode.

14. The UE of claim 13, wherein the one or more processors are further configured to cause the UE to:
receive a spatial indication that associates the SIB transmission with one or more of a synchronization signal block (SSB) beam used to transmit the UL-WUS, all SSB beams associated with the NES cell, or one or more SSB beams neighboring the SSB beam used to transmit the UL-WUS, wherein the SIB transmission is received in accordance with the spatial indication.

15. The UE of claim 7, wherein the one or more processors, to cause the UE to identify the current SIB transmission mode, are configured to cause the UE to:
monitor for a SIB transmission from the NES cell, wherein the current SIB transmission mode is:
the always-on SIB mode in accordance with receiving the SIB transmission within a time period, or
the on-demand SIB mode in accordance with a failure to receive the SIB transmission within the time period.

16. The UE of claim 7, wherein the one or more processors, to cause the UE to identify the current SIB transmission mode, are configured to cause the UE to:
receive, from the NES cell, a master information block (MIB) that includes a SIB physical downlink control channel (PDCCH) configuration or one or more bits indicating the current SIB transmission mode.

17. The UE of claim 16, wherein the one or more processors, to cause the UE to identify the current SIB transmission mode, are configured to cause the UE to:
receive, from the NES cell, a master information block (MIB) that indicates a synchronization signal block (SSB) resource element (RE) offset, wherein the current SIB transmission mode is:
the always-on SIB mode in accordance with a first set of SSB RE offsets including the SSB RE offset indicated in the MIB, or
the on-demand SIB mode in accordance with a second set of SSB RE offsets including the SSB RE offset indicated in the MIB.

18. The UE of claim 7, wherein the UL-WUS configuration indicates the current SIB transmission mode based on one or more of a frequency range, a frequency band, one or more raster locations, or a synchronization signal block subcarrier spacing associated with the NES cell.

19. The UE of claim 7, wherein the one or more processors, to cause the UE to identify the current SIB transmission mode, are configured to cause the UE to:
receive, from the NES cell, a random access response (RAR) message indicating the current SIB transmission mode.

20. A method of wireless communication performed by a user equipment (UE), comprising:
receiving, from a neighbor cell, an uplink wakeup signal (UL-WUS) configuration associated with a network energy savings (NES) cell;
identifying a current system information block (SIB) transmission mode associated with the NES cell in accordance with the UL-WUS configuration indicating that the NES cell supports at least an on-demand SIB mode and an always-on SIB mode; and
acquiring, from the NES cell, system information associated with the NES cell in accordance with the current SIB transmission mode associated with the NES cell.
